(19) United States
(12) Patent Application Publication
(10) Pub. No.: US 2007/0118573 A1
(43) Pub. Date: May 24, 2007

(54) System and method to create a subset of a database

(75) Inventor: Kishore Gadiraju, Sunnyvale, CA (US)

Correspondence Address: William L. Botjer, PO Box 478, Center Moriches, NY, 11934, US

(73) Assignee: SOLIX, INC.

(21) Appl. No.: 11/286,205

(22) Filed: Nov. 23, 2005

(51) Int. Cl. G06F 17/30

(52) U.S. Cl. 707/204

(57) ABSTRACT

A system and method for creating a subset of a database is provided. The database is stored at a first location, and a replica of the database may be stored on a second location. The system comprises an archiving module to archive the subset of the database from the second location to a third location. Further, the system comprises a deleting module to delete the database from the second location and a de-archiving module to de-archive the archived subset from the third location to the second location.

### RELATED APPLICATIONS

This application is related to the following application which is hereby incorporated by reference as if set forth in full in this specification: Co-pending U.S. patent application Ser. No. 11/274,558 entitled ‘System and Method for Managing a Database’, filed on Nov. 15, 2005.

### BACKGROUND OF THE INVENTION

The present invention relates to the field of databases. More specifically, the present invention relates to a system and method for creating a subset of a database, such as a relational database.

Many a times, a subset of a database present in the production environment may need to be provided to a non-production environment such as a test environment or a development environment. For example, the subset may be required for Quality Assurance (QA), testing, staging and training.

Moreover, the creation of multiple subsets requires considerable processing and memory space. The complexity of creating the subsets increases especially when the data contained in each subset differs. Accordingly, the process of selection of data for creating the individually different subsets requires customization as each subset would be created based on corresponding user-defined parameters. Moreover, each subset created should be relationally intact.

### SUMMARY OF THE INVENTION

An objective of the invention is to create a relationally intact subset from a database, such as a relational database.

A system and method for creating a subset of a database is provided. The database is stored at a first location, and a replica of the database may be stored on a second location.

The system comprises an archiving module to archive the subset of the database from the second location to a third location. Further, the system comprises a deleting module to delete the database from the second location and a de-archiving module to de-archive the archived subset from the third location to the second location.

The method includes replicating the database from the first location to the second location, archiving the subset of the database from the second location to the third location, deleting the database from the second location and de-archiving the archived subset to the second location.

Various embodiments of the invention provide an advantageous method of creation of relationally intact subsets of a database. Further the invention provides methods based on the computational capability of the subset creating system and the size of the dataset to be created.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating an exemplary environment, where an embodiment of the invention may be implemented;

FIG. 2 is a block diagram illustrating the subset creating system in accordance with a first embodiment of the invention;

FIG. 3 is a flowchart depicting a method for creating a subset of the database in accordance with the first embodiment of the invention;

FIG. 4 is a block diagram illustrating a system for creating a subset of the database in accordance with a second embodiment of the invention;

FIG. 5 is a flowchart depicting a method for creating a subset of the database in accordance with the second embodiment of the invention; and

FIG. 6 is a block diagram illustrating a subset in accordance with an embodiment of the invention.

### DESCRIPTION OF PREFERRED EMBODIMENTS

Before describing in detail a system and a method for creating a subset of a database, in accordance with the present invention. It should be observed that the present invention resides primarily in combinations of method steps and apparatus components related to a configuration engine. A more detailed description of the configuration engine is provided in a co-pending commonly owned U.S. patent application Ser. No. XXXX, entitled ‘System and Method for Managing a Database’, filed on Nov. 15, 2005. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

Various embodiments of the present invention provide a system and a method for creating a subset of a database. The database may be a relational database.

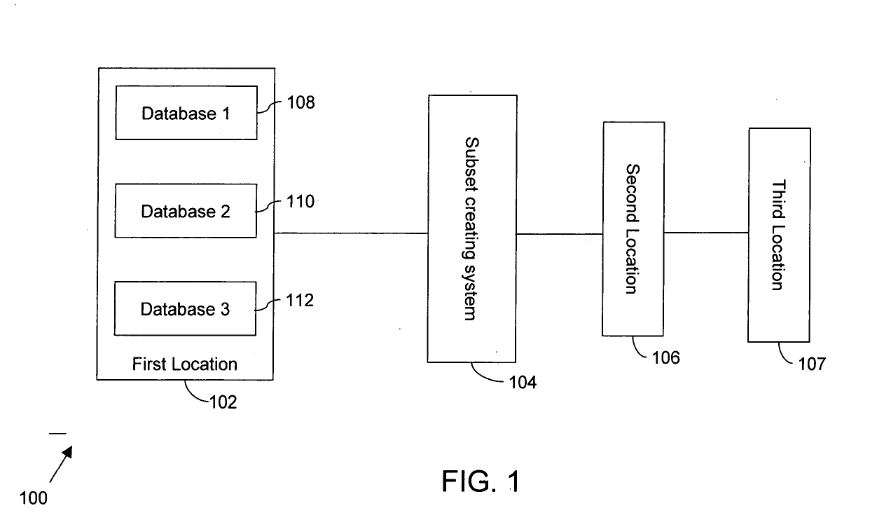

FIG. 1 is a block diagram illustrating an exemplary environment 100, where an embodiment of the invention may be implemented. Environment 100 includes a first location 102, a subset creating system 104, a second location 106 and a third location 107. First location 102 includes databases, including a database 108, a database 110 and a database 112. In an embodiment each of the databases is a relational database that is capable of operating with vendors of Enterprise Resource Application (ERP) systems such as Oracle™, PeopleSoft™ and JD Edwards™. Further, each database may be associated with an application such as a transaction processing system. An example of a transaction processing system includes an Online Transaction processing systems (OLTP) that may be used for electronic banking or order processing.

Each of the databases includes related datasets, exemplified in the form of tables. Further, each of the datasets include data parts exemplified in the form of columns. Another example of a data part is that of a row.

Second location 106 may be used to store replicas of databases stored at first location 102. A subset is created for at least one of the databases stored at first location 102 by subset creating system 104. Subset creating system 104.uses the replicas of databases stored at the second location 106 to create corresponding subsets. Third location 107 is used in conjunction with second location 106. A subset of the database in second location 106 is archived to third location 107. Subsequently, the archived subset is de-archived back to second location 106 after the database in second location 106 is deleted. De-archiving includes transferring the archived subset third location 107 to second location 106. A more detailed description of de-archiving module 208 is provided in co-owned, co pending U.S. patent application Ser. No. 11/274,558, entitled, ‘System and Method for Managing a Database’.

Each of first location 102, second location 106 and third location 107 may be embodied in the form of a storage system such as a hard disk or combination of hard disks that are capable of storing a large amount of data. In an exemplary embodiment, the size of the data varies from 100 Gigabytes to 1 Terabyte. Accordingly, first location 102, second location 106 and third location 107 may be embodied in the form of a Direct Attached Storage (DAS), including internally attached local disk drives or externally attached Redundant Array of Independent Disks (RAID) or Just a Bunch of Disks (JBOD). In another embodiment, first location 102 and second location 106 may be embodied in the form of a Storage Area Network including, for example, a network of storage disks.

In an embodiment first location 102, second location 106 and third location 107 are present on a single physical server or hard disk. Further, the three locations may be logically separated by means of appropriate software. In another embodiment, first location, second location and the third location are present on different physical servers or hard disks as described above.

It may be noted that subset creating system interacts directly with first location 102, second location 106 and third location 107, without the need of an intermediate intelligence layer. Further, first location 102 is only used for either accessing the databases or replicating any of the databases to second location 106.

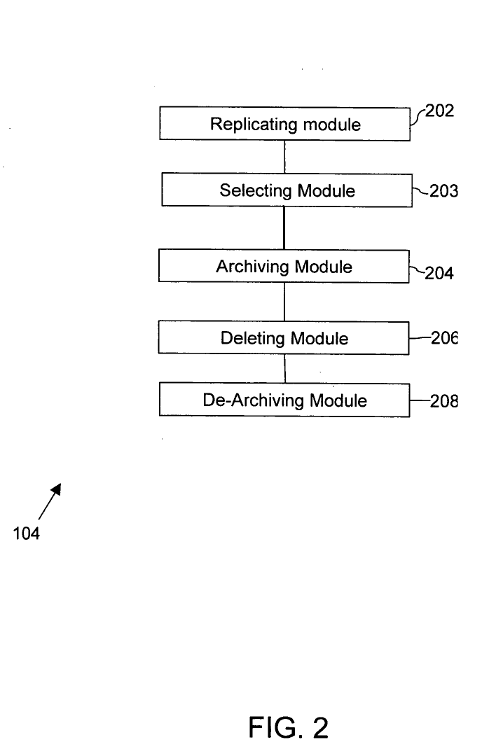

FIG. 2 is a block diagram illustrating subset creating system 104 in accordance with a first embodiment of the invention. Subset creating system 104 includes a replicating module 202, a selecting module 203, an archiving module 204, a deleting module 206, and a de-archiving module 208.

For an explanation of the working of subset creating system 104, consider a case where the subset is created from a database such as database 110, in first location 102.

Replicating module 202 replicates the database from a first location, such as first location 102 to a second location, such as second location 106. Selecting module 203 selects a subset from the database at the second location 106. In an embodiment, the selection of the subset is carried out by the selecting module of a configuration engine described in co-owned, co-pending US Application , entitled, System and Method for Managing a Database.

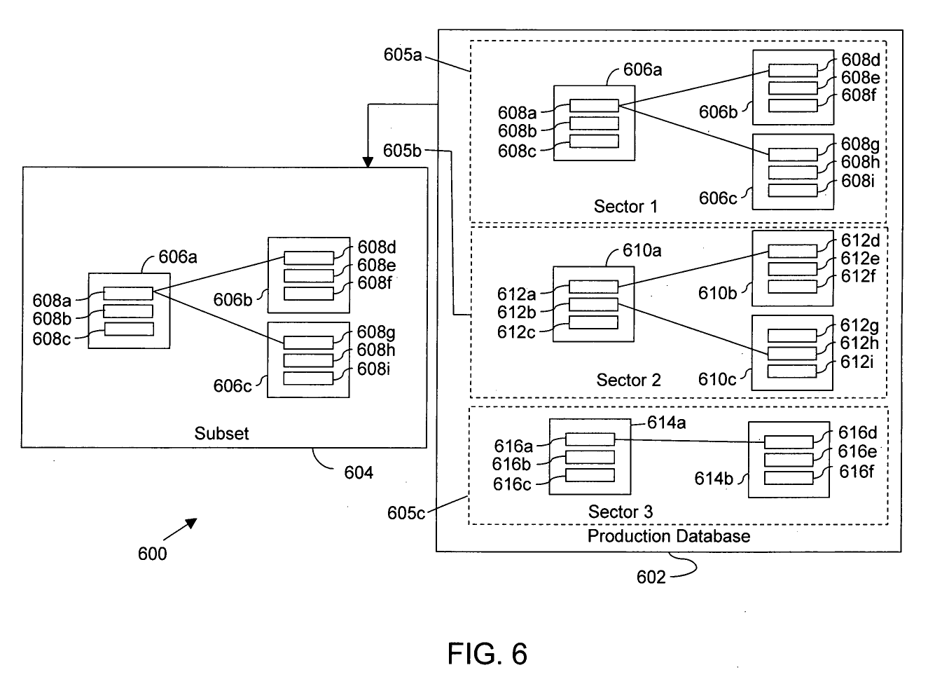

A brief description of the working of the selecting module is as follows: A set of datasets selected from at least one of the databases in first location is registered with the knowledgebase. The knowledgebase stores the names of the registered datasets as well as the relationship between them. Thereafter a configuration is created from the registered datasets. The configuration includes the datasets linked according to their relational model, i.e. a driving table may be linked to one or more related child tables. Subsequently, at least one criterion may be applied to the configuration. The application of the criterion on the configuration enables selection of the subset to be created. An exemplary illustration of the subset is described in conjunction with FIG. 6

It may be noted that the subset created at the second location is relationally intact and maintains the referential integrity of the original database. The referential integrity is maintained as the relationship between the datasets stored in each of the registered databases is stored in the knowledgebase.

Archiving module 204 archives a subset of the database from the second location to a third location, such as third location 107. Deleting module 206 deletes the replicated database from the second location. Subsequently, de-archiving module 208 de-archives the archived subset from the third location to the second location. As a result, the subset is created at second location 106. A more detailed description of archiving module 204 is provided in co-owned, co pending, ‘System and Method for Managing a Database’.

In accordance with another embodiment, subset creating system 104 includes selecting module 203, archiving module 204, deleting module 206, and de-archiving module 208. Accordingly, subset creating system 104 may operate directly with second location 106 when a replica of the database is stored therein.

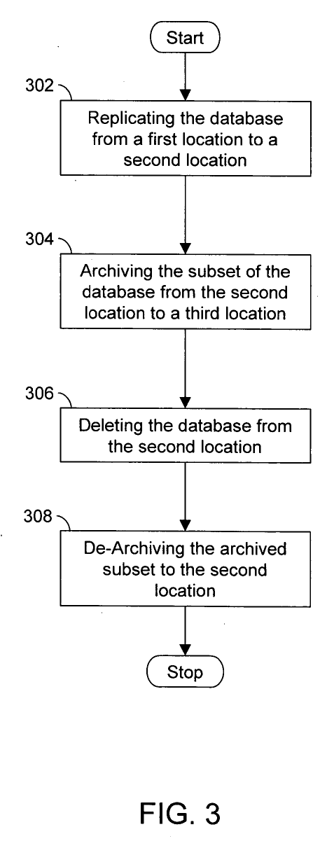

FIG. 3 is a flowchart depicting a method for creating a subset of a database in accordance with the first embodiment of the invention. At step 302, a database such as database 110, is replicated to the second location. In an embodiment, the replication is performed using replicating module 202. At step 304, a subset of the database stored at the second location is archived to the third location. In an embodiment, the process of archiving is performed using archiving module 204. A more detailed description of archiving module 204 is provided in co-owned, co pending U.S. Patent Application entitled, ‘System and Method for Managing a Database’.

At step 306, the database stored at the second location is deleted. At step 308, the archived subset of the database stored at the third location is de-archived to the second location. In an embodiment, the process of de-archiving is performed using de-archiving module 208.

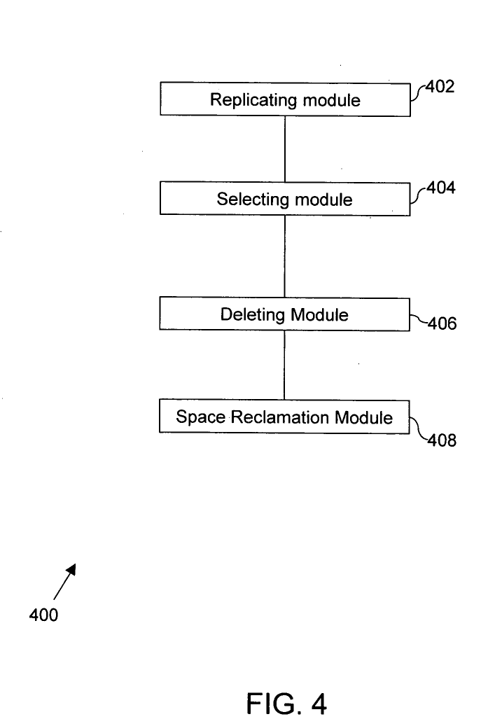

FIG. 4 is a block diagram illustrating a system 400 for creating a subset of a database in accordance with a second embodiment of the invention. System 400 includes a replicating module 402, a selecting module 404, a deleting module 406 and a space reclamation module 408.

Replicating module 402 creates a replica of a database, such as database 110, from the first location, and stores the copy at the second location. Thereafter, selecting module 404, which functions in a similar manner as selecting module 203 described with reference to FIG. 2, performs the following steps:

a) identification of at least two parts of the database, such as, a first part and a second part.

b) selection of the first part of the database.

Finally, deleting module 406 deletes the first part. The second part is therefore retained in second location 106 and forms the subset of the database.

In an embodiment, the first part is substantially larger in size than the second part. For example, if the first part and the second part account for the entire size of the database replicated to second location 106, the first part would account for more than or equal to at least 75 percent of the entire size.

Space reclamation module 408 reclaims the space from the physical memory of second location 106 once the deletion of the first part of the database takes place. This is carried out to free the physical memory for reuse by future data as the physical memory may not be available for use after the deletion of the first part takes place.

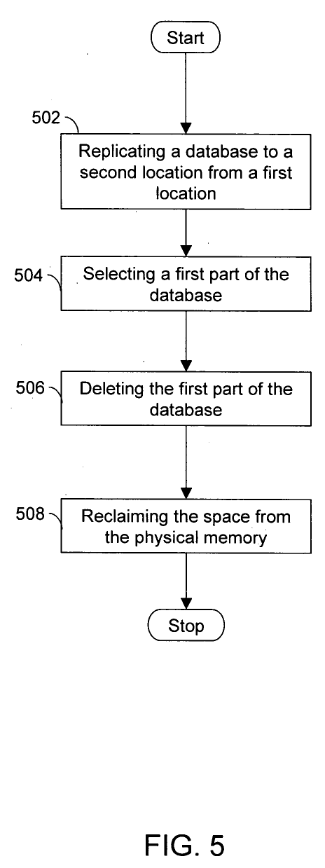

FIG. 5 is a flowchart depicting a method for creating a subset of a database in accordance with the second embodiment of the invention. At step 502, a database, such as database 110 is replicated from the first location to the second location. In an embodiment, the process of replication is performed using replicating module 402. Thereafter, at least two parts of the database are identified such as, for example, a first part and a second part, each part being relationally intact.

At step 504, the first part of the database is selected. In an embodiment, the selection is performed using selecting module 404. At step 506, the first part of the database is deleted from the second location. The deletion may be performed using deleting module 406.

After the above steps have been performed, the memory space that was occupied by the first part is reclaimed in the physical memory at step 508.

In various embodiments, the choice of the implementation of the two methods described above (in FIG. 3 and FIG.5) depends on factors such as the size of the subset to be created, computational capability of the subset creating system and the processing power required for creation of the subset. For example, if less than or equal to approximately 25 percent of the database is to be deleted, then the first method as described with reference to FIG. 3 may be used. Accordingly, if the size of the database to be deleted exceeds approximately 75 percent of the total size, then the second method as described with reference to FIG. 5 may be employed as archiving a substantially large portion of the database and subsequently de-archiving it would prove to be more expensive and time consuming.

It may be apparent to a person skilled in the art that the methods described with reference to FIG. 3 and FIG. 5 may be extended to create more than one subsets from a database.

FIG. 6 is a block diagram illustrating an exemplary subset in accordance with an embodiment of the invention. Database 600 includes a production database, such as a production database 602 and a subset, such as subset 604.

In an embodiment, production database 602 is a database that stores datasets corresponding to three sectors of the economy namely a set of datasets 605a, a set of datasets 605b and a set of datasets 605c. For exemplary purposes, datasets 605a(Sector 1) corresponds to the health sector, datasets 606a (Sector 2) corresponds to financial sector, while datasets 605c (Sector 3) corresponds to the services sector.

In an embodiment, a data set may be exemplified in the form of a table and the data parts in each of the data sets may be exemplified in the form of columns.

Datasets 605a includes a plurality of related data sets 606a to 606c. Data set 606a includes data parts 608a, 608b and 608c. Similarly, data set 606b includes data parts 608d, 608e and 608f, data set 606c includes data parts 608g, 608h and 608i. Data part 608a is related to data part 608d and data part 608g.

Further, data sets 605b includes a plurality of related data sets 612a to 612c. Data set 610a includes data parts 612a, 612b and 612c. Similarly, data set 610b includes data parts 612d, 612e and 612f, data set 610c includes data parts 612g, 612hand 612i. Data part 612a is related to data part 612d, while data part 612b is related to data part 612h.

Datasets 605c include a plurality of related data sets 614a and 614b. Dataset 614a includes data parts 616a, 616b and 616c, while dataset 614b includes data parts 616d, 616e and 616f. Data part 616a is related to data part 616d.

Subset 604 is an exemplary subset of production database 602 corresponding to datasets 605a. Subset 604 may be created by either of the methods described with reference to FIG. 3 and FIG. 5. Accordingly, subset 604 includes datasets 606a, 606b, 606c and 606d having the same referential integrity as that of datasets 605a.

In an exemplary embodiment, subset 604 is created by a vertical split of production database 602. The rationale of the creation of the dataset may be based on factors such as business logic or policies. For example, the production database may be a proprietary database of an organization, such as a research organization which may require the creation of a subset related to the sector 1 (datasets 605) which needs to be studied in greater detail by a dedicated group of researchers.

Another rationale for the creation of a subset is in the case of a horizontal split, wherein the subset may be created based on a factor such as time. For example, a business rule may specify that out of ten years' worth of data for employees registered with an organization, a subset of the data corresponding to the last two years be created to be stored or archived permanently.

Various embodiments of the invention provide an advantageous method of creating a relationally intact subset of a database. Further the invention provides methods according to the size of the dataset to be created and on the computational capability of the subset creating system. The method of selection of the subset may be customized according to unique requirements as the system uses the functionalities of the configuration engine described in co-owned, co-pending US Application Serial entitled, System and Method for Managing a Database.

The subset creating system, as described in the present invention, or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. Microprocessor is connected to a communication bus. Computer also includes a memory. Memory may include Random Access Memory (RAM) and Read Only Memory (ROM). Computer system further comprises storage device. It can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system for creating a subset of a database stored at a first location, a replica of the database being stored on a second location, the system comprising:
a. an archiving module to archive the subset of the database from the second location to a third location;
b. a deleting module to delete the database from the second location; and
c. a de-archiving module to de-archive the archived subset from the third location to the second location.

2. The system of claim 1, wherein the database is a relational database.

3. The system of claim 1 further comprising a replicating module to replicate the database from the first location to the second location.

4. A method for creating a subset of a database stored at a first location, the method comprising the steps of:
a. replicating the database from the first location to a second location;
b. archiving the subset of the database from the second location to a third location;
c. deleting the database from the second location; and
d. de-archiving the archived subset to the second location.

5. A system for creating a subset of a database stored at a first location, a replica of the database being stored on a second location, the database comprising at least a first part and a second part, the system comprising:
a. a selecting module to select the first part of the database in the second location, the selection being performed using a configuration engine; and
b. a deleting module to delete the first part of the database.

6. The system according to claim 5, further comprising a replicating module to replicate the database from the first location to the second location.

7. The system according to claim 5, wherein the configuration engine comprises a selecting module to select the first part of the database, based on at least one criterion.

8. A method for creating a subset of a database stored at a first location, the database having at least a first part and a second part, the method comprising:
a. replicating the database from the first location to the second location;
b. selecting the first part of the database in the second location, the selection being performed using a configuration engine; and
c. deleting the first part of the database from the second location.

9. A computer program product for creating a subset of a database stored at a first location, the computer program product comprising a computer readable medium comprising:
a. program instruction means for replicating the database from the first location to a second location;
b. program instruction means for archiving the subset of the database from the second location to a third location;
c. program instruction means for deleting the database from the second location; and
d. program instruction means for de-archiving the archived subset to the second location.

10. A computer program product for creating a subset of a database stored at a first location, the computer program product comprising a computer readable medium comprising:
a. program instruction means for replicating the database from the first location to the second location;
b. program instruction means for selecting the first part of the database in the second location, the selection being performed using a configuration engine; and
c. program instruction means for deleting the first part of the database from the second location.
